(19) United States
(12) Patent Application Publication
(10) Pub. No.: US 2022/0028598 A1
(43) Pub. Date: Jan. 27, 2022

(54) MAGNETIC INDUCTION ASSEMBLY

(71) Applicants: Chih-Hung Lin, New Taipei City (TW); Kun-Chuan Chang, New Taipei City (TW)

(72) Inventors: Chih-Hung Lin, New Taipei City (TW); Kun-Chuan Chang, New Taipei City (TW)

(73) Assignee: PIN SHINE INDUSTRIAL CO., LTD., New Taipei City (TW)

(21) Appl. No.: 16/936,472

(22) Filed: Jul. 23, 2020

(51) Int. Cl. H01F 27/28; H01F 27/24; H01F 27/06

(52) U.S. Cl. CPC H01F 27/2823; H01F 27/06; H01F 27/24

(57) ABSTRACT

A magnetic induction assembly includes a magnetic core, a primary winding, a secondary winding and a base. The primary winding is wound by a wire. The secondary winding is a conductive plate having an open loop and two contact ends. The base has a body having a through hollow. A surface of the body is formed with n partitions, where n is greater than or equal to 1. The partitions divide the body into n+1 winding areas for being selectively wound by the wire. Each of the partitions has a chamber, a through hole communicating with the through hollow and an opening allowing the secondary winding to enter the chamber. The magnetic core passes through the through hollow, the through holes and the loop of the conductive plate to magnetically couple with the primary winding and the secondary winding.

### TECHNICAL FIELD

The invention relates to inductors, particularly to inductors which serve as transformers.

### RELATED ART

A transformer is composed of a core and a coil. Usually, the coil has two or more windings. The winding connected to a power is called “primary winding”, and the other windings are called “secondary windings”. Transformers have functions of step-up, step-down, signal coupling, energy transfer, impedance change and isolation.

Leakage inductance derives from the electrical property of an imperfectly-coupled transformer whereby each winding behaves as a self-inductance in series with the winding's respective ohmic resistance constant. These four winding constants also interact with the transformer's mutual inductance. The winding leakage inductance is due to leakage flux not linking with all turns of each imperfectly-coupled winding. Leakage inductance is distributed in all windings and is connected with a winding in series. Energy resulting from leakage inductance cannot be released to the secondary winding, so a larger voltage peak will occur to cause higher voltage stress and heating while the power is being switched. Also, performance of the overall transformer will become bad. Usually, leakage inductance of transformer relates to the turns of primary winding. Theoretically, Leakage inductance can be reduced by decreasing the turns of secondary winding.

A solution of reducing the leakage inductance is to divide the primary winding into an inner layer and an outer layer (also known as sandwich winding) and to place the secondary winding between the two layers.

In the sandwich winding, the primary or secondary winding is formed by winding a wire on a bobbin. As abovementioned, the secondary winding is sandwiched between the two layers of the primary winding, the wire of the primary winding has to cross the secondary winding. Automatic production is hard to be introduced if layout is not properly arranged. Also, safe isolation between two windings cannot be established.

### SUMMARY OF THE INVENTION

An object of the invention is to provide a magnetic induction assembly, which is advantageous to automatic production.

Another object of the invention is to provide a magnetic induction assembly, which can reduce adverse influence to a transformer from the leakage inductance to further decrease loss of a transformer and a switch.

To accomplish the above objects, the magnetic induction assembly of the invention includes a magnetic core, a primary winding, a secondary winding and a base. The primary winding is wound by a wire. The secondary winding is a conductive plate having an open loop and two contact ends. The base has a body having a through hollow. A surface of the body is formed with n partitions, where n is greater than or equal to 1. The partitions divides the body into n+1 winding areas for being selectively wound by the wire. Each of the partitions has a chamber, a through hole communicating with the through hollow and an opening allowing the secondary winding to enter the chamber. The magnetic core passes through the through hollow, the through holes and the loop of the conductive plate to magnetically couple with the primary winding and the secondary winding.

Each of the partitions 3 is formed with at least one slot. A part of the wire of the primary winding, which crosses the secondary winding, is secured in the slots to prevent from being interfered and to form electrical isolation the wire and the secondary winding.

The secondary winding is a conductive plate. The conductive plate has an open loop and two contact ends. The loop is coated with an insulative isolation layer. A separator is provided between the two contact ends.

### BRIEF DESCRIPTION OF THE DRAWINGS

FIG. 1 is an exploded view of the invention;

FIG. 2 is a perspective view of the invention;

FIG. 3 is another perspective view of the invention;

FIG. 4 is a top plan view of the coil module of the invention;

FIG. 5 is a cross-sectional view along line 5-5 in FIG. 4;

FIG. 6 is a cross-sectional view along line 6-6 in FIG. 4;

FIG. 7 is a bottom plan view of the coil module of the invention; and

FIGS. 8-10 are bottom plan views of other embodiments of the coil module of the invention.

### DETAILED DESCRIPTION OF THE INVENTION

The magnetic induction assembly of the invention may be, but not limited to, an inductor or a transformer.

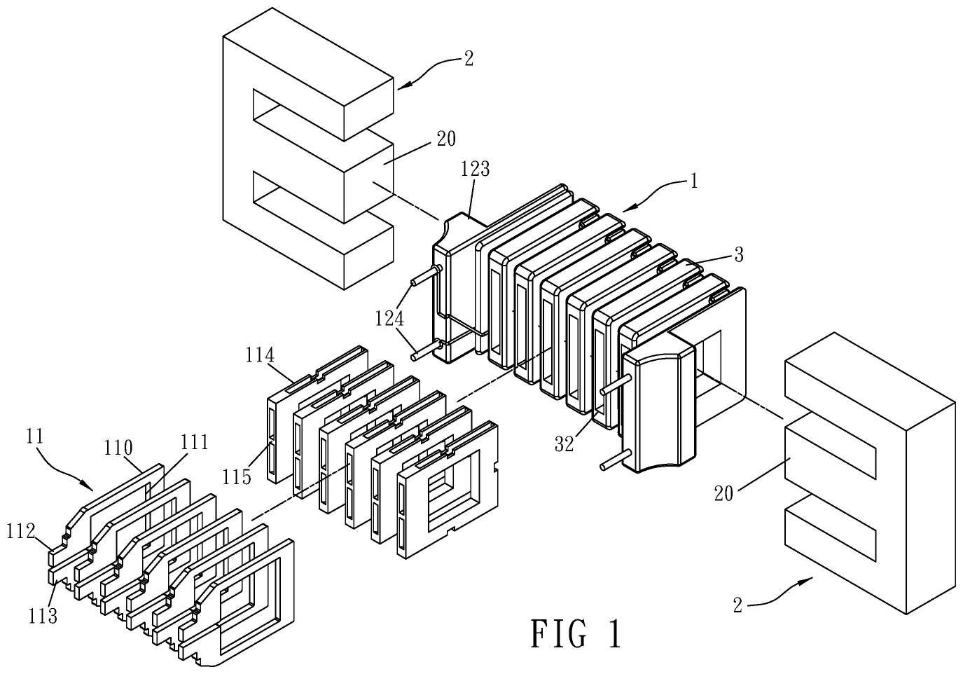

Please refer to FIG. 1. The invention includes a coil module 1 and a magnetic core 2. The magnetic core 2 is surrounded by the coil module 1. The coil module 1 is magnetically coupled with the magnetic core 2.

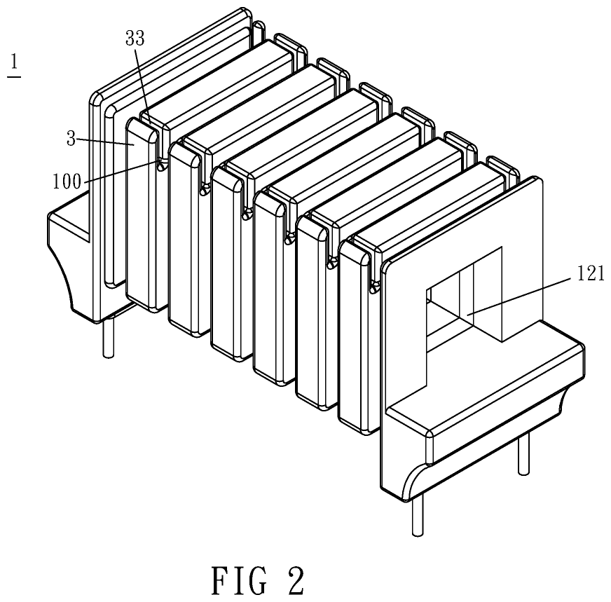

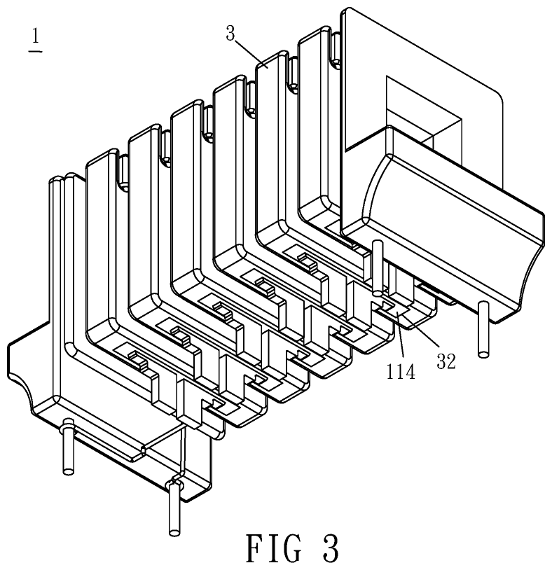

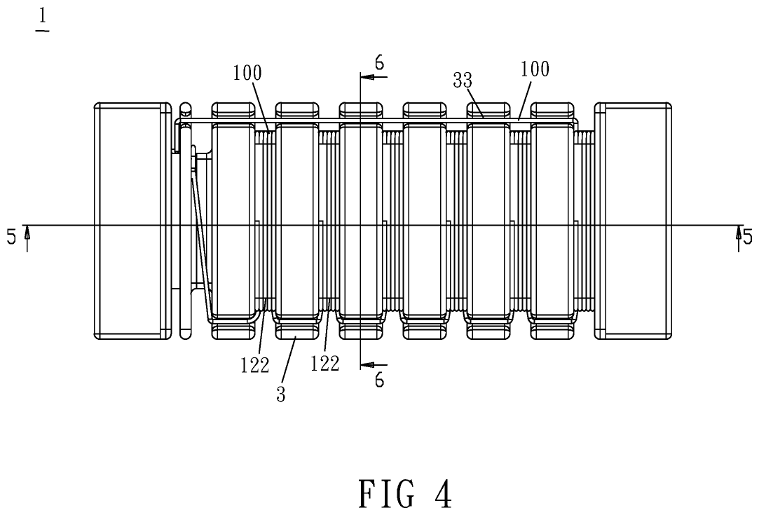

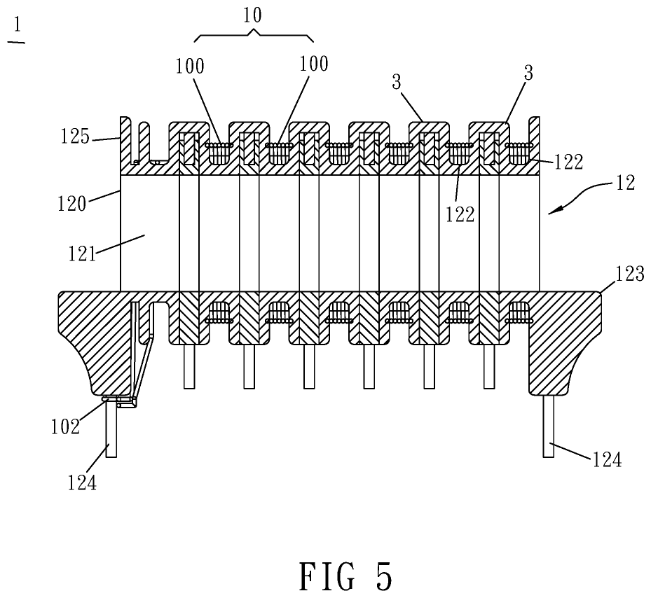

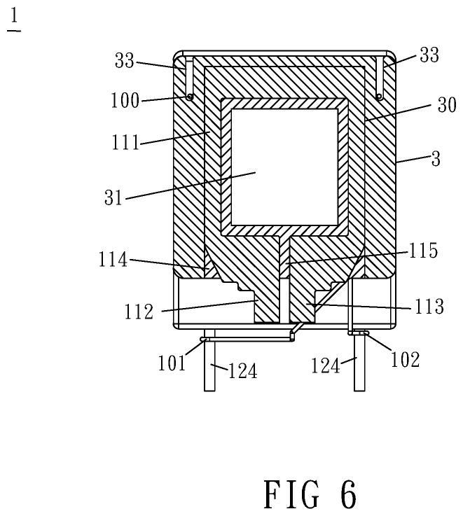

Please refer to FIGS. 2-7. As a transformer, the coil module 1 includes a primary winding 10, a secondary winding 11 and a base 12. The primary winding 10 and the secondary winding 11 are fixed on the base 12 to make a voltage ratio which is equal to a turns ratio.

The base 12 has a body 120 for being mounted by the primary winding 10. The body 120 has a through hollow 121. A surface of the body 120 is formed with n partitions 3, where n is greater than or equal to 1. The partitions 3 divide the body into n+1 winding areas 122. In the figures, the partitions 3 project from a surface of the body 120 and are integratedly formed with the body 120 in one piece, but not limited to this. Besides, each of two opposite ends of the body 120 is connected with a carrier 123 for bearing the magnetic core 2 as shown in FIG. 1. The carrier 123 is provided with at least one conductive pin 124 for external connection. Preferably, the carrier 123 is further provided with a baffle 125 which is parallel with the partitions 3 for electric isolation.

Each of the partitions 3 has a chamber 30, a through hole 31 communicating with the through hollow 121 and an opening 32 allowing the secondary winding 11 to enter the chamber 30. The magnetic core 2 passes through the through hollow 121 and the through holes 31. Each of the partitions 3 is formed with at least one slot 33. In the shown embodiment, the slot 33 is two in number.

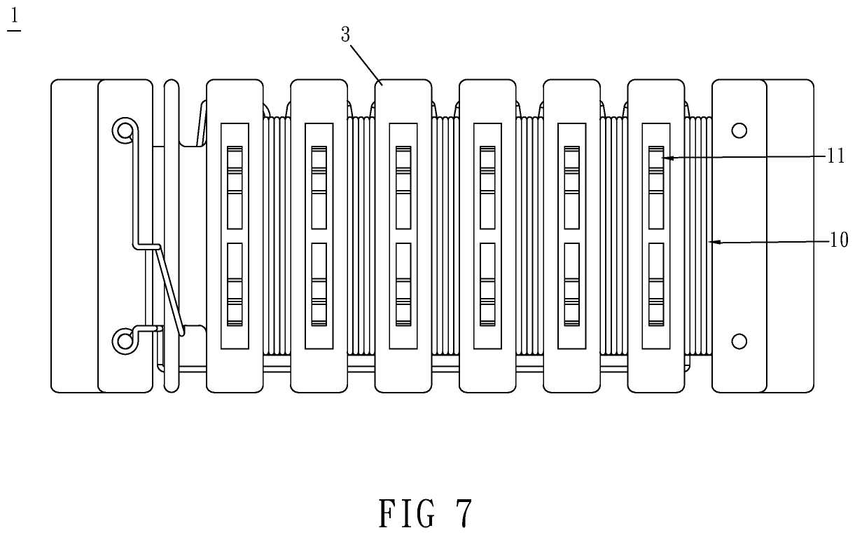

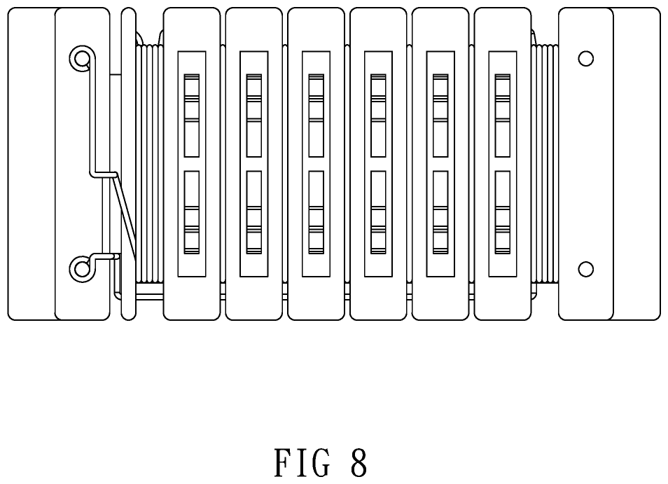

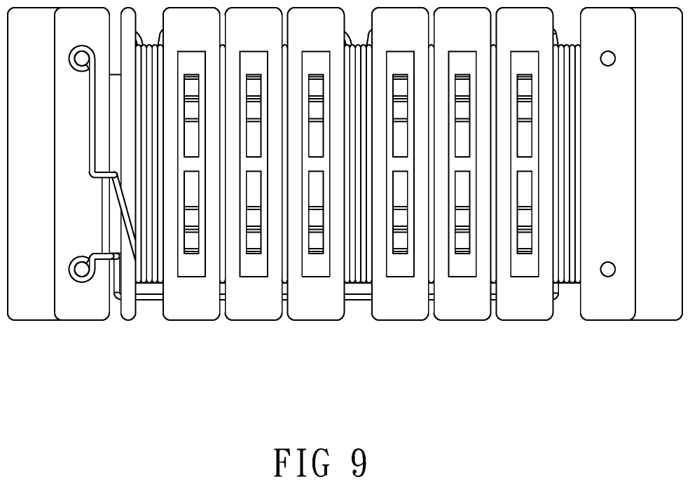

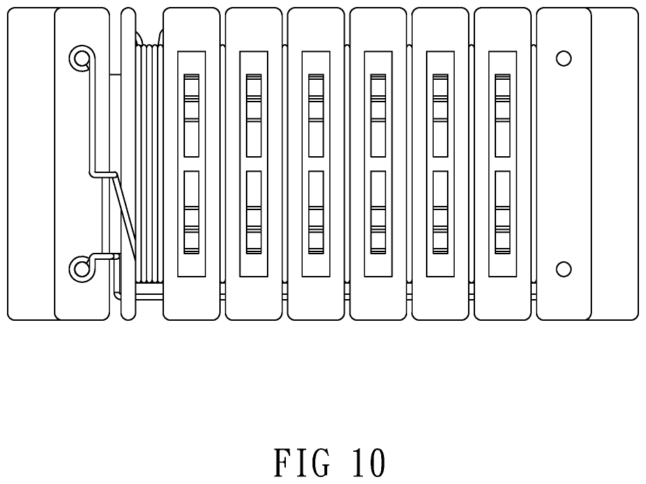

The primary winding 10 is wound by a wire 100. The wire 100 may be an enameled wire or a triple insulation wire. The wire 100 is wound on the body 120 of the base 12. In detail, as shown in FIGS. 7-10, the wire 100 is selectively wound in different winding areas 122 divided by the partitions 3, or the secondary winding 11 is sandwiched therebetween to form a sandwich winding. A part of the wire 100, which crosses the secondary winding 11, is secured in the slots 33 to prevent from being interfered and to form electrical isolation the wire 100 and the secondary winding 11. This is advantageous to automatic production. Finally, two ends of the wire 100 are separately connected to the conductive pins 124. The primary winding 10 will generate a magnetic field and electrically couple with the magnetic core 2 when the conductive pins 124 are connected with an electric power.

The secondary winding 11 is a conductive plate 110. The conductive plate 110 has an open loop 111 and two contact ends 112, 113 for external connection such as a load. To enhance electric isolation, the loop 111 is coated with an insulative isolation layer 114. A separator 115 is provided between the two contact ends 112, 113 to avoid short circuit. The isolation layer 114 may be formed by directly injecting an insulative material on the loop 111.

The conductive plate 110 with the isolation layer 114 is inserted into the chamber 30 through the opening 32. The contact ends 112, 113 are exposed for external connection.

Please refer to FIGS. 7-10. The turns of the secondary winding 11 can be added to satisfy demands of users. The contact ends 112, 113 can be connected with an external circuit for better availability. In particular, the partitions 3 not only increase a safety distance between the primary winding 10 and the secondary winding 11, but also decrease the occupied space.

It will be appreciated by persons skilled in the art that the above embodiments have been described by way of example only and not in any limitative sense, and that various alterations and modifications are possible without departure from the scope of the invention as defined by the appended claims.

What is claimed is:

1. A magnetic induction assembly comprising:
a magnetic core;
a primary winding wound by a wire;
a secondary winding, being a conductive plate, and the conductive plate having an open loop and two contact ends; and
a base, having a body, the body having a through hollow, a surface of the body being formed with n partitions which are outward extended, n being greater than or equal to 1, and the partitions dividing the body into n+1 winding areas for being selectively wound by the wire;
wherein each of the partitions has a chamber, a through hole communicating with the through hollow and an opening allowing the secondary winding to enter the chamber, and the magnetic core passes through the through hollow, the through holes and the loop of the conductive plate to magnetically couple with the primary winding and the secondary winding.

2. The magnetic induction assembly of claim 1, wherein each of the partitions is formed with at least one slot for being embedded by the wire crossing the secondary winding.

3. The magnetic induction assembly of claim 2, wherein the slot is two number at two corners of the partition.

4. The magnetic induction assembly of claim 1, wherein the loop is coated with an insulative isolation layer, and a separator is provided between the two contact ends.

5. The magnetic induction assembly of claim 1, wherein each of two opposite ends of the body is connected with a carrier.

6. The magnetic induction assembly of claim 5, wherein the carrier is provided with at least one conductive pin connected with the wire of the primary winding.

7. The magnetic induction assembly of claim 5, wherein carrier is provided with a baffle which is parallel with the partitions.
